(19) United States
(12) Patent Application Publication
(10) Pub. No.: US 2021/0293526 A1
(43) Pub. Date: Sep. 23, 2021

(54) GEOMETRIC PHASE SHEAROGRAPHY SYSTEM AND METHOD THEREOF

(71) Applicant: BAE Systems Information and Electronic Systems Integration Inc., Nashua, NH (US)

(72) Inventor: Jacob D. Garan, Honolulu, HI (US)

(73) Assignee: BAE Systems Information and Electronic Systems Integration Inc., Nashua, NH (US)

(21) Appl. No.: 16/823,918

(22) Filed: Mar. 19, 2020

(51) Int. Cl. G01B 9/02; G01N 21/45; G01B 11/16

(52) U.S. Cl. CPC G01B 9/02098; G01B 11/162; G01N 21/45

(57) ABSTRACT

A shearography system uses a Geometric phase or Pancharatnam-Berry (PB) phase element to shear an image. A PB phase element provides a non-dynamical phase change used for wavefront control and results in uniform half-wave of retardation. Geometric phase may also be utilized to capture snapshot phase-resolved wavefront measurements and shearograms via a focal plane array with micro-patterned linear polarizers of different orientations. Wavefront shape control arises when the local orientation of the retarding media is spatially varied. One or more PB phase elements can be flipped or rotated to perform multiple tasks depending on its orientation. Two PB elements can be used in succession in order to provide a variable purely spatial shift between interfering wavefronts. The spatial offset of the light exiting the second element can be adjusted simply by changing the spacing between the two geometric phase surfaces. In shearography, this corresponds to an adjustable shear length.

### TECHNICAL FIELD

The present disclosure relates generally to shearography systems. More particularly, the present disclosure relates to a shearography system utilizing geometric phase optical elements. Specifically, the shearography system has geometric phase resolved optical elements that enable an adjustable shear and instantaneous phase measurements.

### BACKGROUND

### Background Information

In Non Phase Resolved (NPR) shearography, a target surface, part, or area being observed is illuminated by an expanding laser beam, and two time-sequential images are captured of the target surface, part, or area with an image-shearing camera. The first image is taken of the surface, and the second image is taken of the same surface a short time thereafter during deformation or loading of the surface. The two images taken are processed together to produce a third image (S₃) (i.e., a shearogram) showing a fringe pattern that depicts the gradient of the displacement of the surface due to some loading of the surface between the first (S₁) and second (S₂) specklegram images.

|S₃|=S₁−S₂| (1)

In Phase Resolved (PR) shearography, a target surface, part, or area being observed is illuminated by an expanding laser beam as with NPR shearography, and two or more time-sequential images are captured of the target surface, part, or area with an image-shearing camera. The first image is taken of the surface, and subsequent images are taken of the same surface as a function of relative phase shift between paths of the interferometer component and time after the first measurement. The phase shift may be applied between images over time or it may be captured instantaneously with a focal plane array (FPA) that has linear polarizer elements printed in different orientations for each pixel and are processed together to produce a third image (i.e., a phase-resolved shearogram) showing a phase map that depicts the gradient of the displacement of the surface due to some loading of the surface between the first and second images. Such a phase map can be computed by common phase reconstruction routines based on prior knowledge of how the interferometer shifts phase between measurements. A common method to reconstruct phase is to measure the interference pattern shifts from an interferometer at four known, equally spaced, phase differences between interferometer arms and process the four digital images using the well-known four-shot phase reconstruction equation (1) for each pixel in the digital image. I₁ represents the specklegram image with 0° phase shift, I₂ represents the specklegram image with 90° phase shift, I₃ represents the specklegram image with 180° phase shift, I₄ represents the specklegram image with 270° phase shift where the angle represents the phase difference between interferometer arms for a given light wavelength.

$$Δ = arctan ( \frac{{I}_{4} - {I}_{2}}{{I}_{1} - {I}_{3}} ) \qquad ( 2 )$$

More particularly, shearography is an optical measuring technique using coherent light for the interferometric observation of the surfaces typically under non-destructive thermal or mechanical loading to distinguish between structural information and anomalies of the surfaces or parts due to loading such as thermal or mechanical loading. The two images are each laterally displaced images taken of the surface, part, or area being observed and the two images are coherently superposed. The lateral displacement is called the shear of the images. The superposition of the two images is called a specklegram, which is an interferogram of an object wave with the sheared surface wave as a reference wave.

The absolute difference of two specklegrams recorded at different physical loading conditions of the target surface, part, or area is an interference fringe pattern which is directly correlated to the difference in the deformation state of the target surface, part, or area between taking the two images thereof. In contrast to holographic interferometry, the fringe pattern in NPR shearography indicates the magnitude (but not the sign or phase) of the slope of deformation rather than the deformation itself. Defects inside the target surface, part, or area will affect the local surface deformation induced by the loading and result in a disturbance of the loading fringes that are detected.

The resultant difference images or shearograms always exhibit a very noisy structure. This is due to speckles, which are defined as statistical interference patterns which occur after reflection of a coherent wave off a rough surface, giving the image a grainy structure. Regarding shearography, the speckles are the carrier of information, coding the wave field and surface state information respectively and giving rise to interference fringe patterns. However, the grainy nature of the speckles is conserved and significantly decreases contrast and signal to noise ratio of the shearograms.

One method of further image processing, which is usually used for processing phase resolved shearograms, includes utilizing a median filter in order to recover desired phase information.

Traditionally, in a temporal-stepping shearography apparatus of a system which includes a Michelson-type interferometer comprising one or more laser transmitters, a beam splitter, first and second mirrors, an image-shearing camera, (which generally may be referred to as a “sensor”) and at least one non-transitory computer readable storage medium having instructions encoded thereon that, when executed by at least one processor implements various logics. One of the mirrors is steppable or movable to provide a phase-stepping system. An untilted mirror is a steppable mirror adjacent a tilted mirror for adjusting the shear tilt. Using the untilted mirror as the stepper provides mechanical simplicity and robustness. A piezo-electric actuator is provided in operative communication with mirror for moving mirror. Alternately, an electronically controllable phase retarder may be used, but this will reduce throughput possibly requiring use of additional laser power. The piezo-electric actuator is controlled to vibrate mirror and the laser transmitter is controlled or triggered to fire at the desired mirror positions, that is, when the mirror is at respective desired positions.

Although a Michelson-type interferometer is often suitable, a variety of shearing interferometers may be used, such that the interferometer is configured to collect multiple shearographic images with controlled phase differences between the arms of the interferometer. A shearing configuration of any interferometer type is usable. For example, and without limitation, suitable interferometers may include glass-plate or glass-wedge interferometers, air-wedge interferometers, Mach-Zender interferometers and the like. Multi-port versions of any type of shearing interferometer may also be used.

### SUMMARY

Issues continue to exist with processing phase resolved shearography. The present disclosure addresses these and other issues by providing a system and method for capturing and generating phase resolved shearograms. The present disclosure addresses these and other issue by taking advantage of an uncommonly used optical phenomenon called Geometric phase or PB phase in order to shear an image. Recent developments have made PB elements commercially available. Light undergoes an additional “geometric phase shift” proportional to the solid angle subtended on the Poincare sphere during its polarization transformation. A geometric phase element provides a uniform half-wave retardation for incoming light, so a right-hand circular input polarization state switches to a left-hand circular polarization and vice-versa. Wavefront shape control arises when the orientation of the retarding media and polarization evolution is spatially varied. The thickness of such an element is the same throughout, so it can be made very thin (micron-scale). Geometric phase surfaces are self-referencing, extremely thin (0.45 mm), can be scaled to large apertures, introduce minimal wavefront error (<lambda/10), inexpensive, and can be re-designed for many desired output wavefronts (thin lens, thin axicon). Another convenient feature of the PB phase element is that it can be flipped in one orientation and LCP will be diffracted one direction, and in another orientation it will diffract the LCP light in the opposite direction. This property allows the same optical element design to perform multiple tasks depending on its orientation. In the case of shearography, two 1-D grating PB elements can be used in succession in order to provide a purely spatial shear of incoming wavefront. The first element will separate the RCP and LCP light into two orders separated in their angle of exitance, and the second element will undo that change in angle. By taking advantage of this, the spatial offset of the RCP and LCP light exiting the second surface can be adjusted simply by changing the spacing between the two geometric phase surfaces. The spatial offset of the light exiting the second element can be adjusted simply by changing the spacing between the two geometric phase surfaces. The angular offset of the light exiting the second element can be adjusted simply by rotating a second PB element relative to a first PB about the optical axis (i.e., rotating the second PB element allows for another degree of freedom in changing shear) In shearography, this corresponds to an adjustable shear length. The orientation of the second element can also be rotated 180 degrees so that it doubles the angle change of the first PB element instead of correcting it. Another method to change shear is to make a PB element out of a spatially patterned birefringent material or spatially patterned waveplate material, so that when a voltage is applied the spatially patterned birefringent material or spatially patterned waveplates align with the electric field it loses its GP lensing effect and when the voltage is removed the spatially patterned birefringent material or spatially patterned waveplates return to their original orientation. Another method of shear adjustment with a pair of PB elements is to adjust their roll orientation between 0 and 180 degrees about the optical axis, where the angle of separation can be varied between zero ray deviation and twice the ray deviation of the individual PB elements. The roll orientation method is similar to the functionality of a Risley prism pair, using geometric phase as its ray deviation mechanism as opposed of dynamic phase.

In one aspect, an exemplary embodiment of the present disclosure may provide a shearography system comprising: a first phase material that is either a geometric phase material or Pancharatnam-Berry (PB) phase material; a second phase material that is either a geometric phase or PB phase material, wherein the second phase material is optically subsequent to the first material; and a first polarization orientation of the first phase material and a different second polarization orientation of the second phase material adapted generate a spatial shift between optical wavefronts moving from the first phase material and into the second phase material. In this exemplary embodiment or another exemplary embodiment, the present disclosure may provide a linear polarizer optically subsequent to the second phase material; and a sensor optically subsequent to the linear polarizer. In this exemplary embodiment or another exemplary embodiment, the present disclosure may provide a constant separation angle between right-hand circular polarization (RCP) wavelengths and left-hand circular polarization (LCP) wavefronts separated by the first phase material; wherein the second phase material is oriented to negate the constant separation angle. In this exemplary embodiment or another exemplary embodiment, the present disclosure may provide an exit surface of the second phase material, wherein the RCP and LCP wavefronts exit the exit surface. In this exemplary embodiment or another exemplary embodiment, the present disclosure may provide spatial offset logic configured to adjust the spatial offset of the RCP and LCP wavefronts exiting the exit surface. In this exemplary embodiment or another exemplary embodiment, the present disclosure may provide wherein the spatial offset logic alters a distances between the first material and the second material that is adapted to provide an adjustable shear length. In this exemplary embodiment or another exemplary embodiment, the present disclosure may provide a constant separation angle between right-hand circular polarization (RCP) wavefronts and left-hand circular polarization (LCP) wavefronts separated by the first phase material; wherein the second material is oriented as having been rotated 180° relative to the first material to double the constant separation angle. In this exemplary embodiment or another exemplary embodiment, the present disclosure may provide wherein the first and second phase elements self-interfere wavefronts originating form points on a target that are spatially separated by a shear length.

Similarly, another exemplary embodiment may provide a shearing element for a shearography system with an adjustable shear, the shearing element comprising: a geometric phase optical material to shear an image by interfering with wavefronts originating from points that are spatially separated on a surface by a shear length; wherein wavefronts undergo a geometric phase shift proportional to a diffraction angle after polarization transformation. This exemplary embodiment or another may further provide the geometric phase optical material is a Pancharatnam-Berry (PB) phase material comprising a uniform half-wave retardation of wavelengths incoming to the phase material; and a polarization shift effectuated by the uniform half-wave retardation of wavelengths, wherein the polarization shift switch one of (i) right-hand circular polarization wavelengths to left-hand circular polarization and (ii) left-hand circular polarization wavelengths to right-hand circular polarization. This exemplary embodiment or another may further provide a spatially varied orientation of the phase material and polarization evolution adapted control wavefront shape of incoming wavelengths. This exemplary embodiment or another may further provide a uniform thickness of the phase material having spatially varied orientation throughout the uniform thickness, wherein the uniform thickness is in a range from about 1 micron to about 20 microns thick. This exemplary embodiment or another may further provide wherein the shearing element does not include a traditional division of amplitude or division of wavefront self-referencing interference.

In another aspect, an exemplary embodiment of the present disclosure may provide a shearing element for a shearography system with an adjustable shear, the shearing element comprising: a geometric phase optical material to shear an image by interfering with wavefronts originating from points that are spatially separated on a surface by a shear length. In this exemplary embodiment or another exemplary embodiment, the present disclosure may provide the geometric phase optical material is a Pancharatnam-Berry (PB) phase material. In this exemplary embodiment or another exemplary embodiment, the present disclosure may provide wherein the geometric phase optical material comprises: a uniform half-wave retardation of wavelengths incoming to the phase material. In this exemplary embodiment or another exemplary embodiment, the present disclosure may provide a polarization shift effectuated by the uniform half-wave retardation of wavelengths, wherein the polarization shift switch one of (i) right-hand circular polarization wavelengths to left-hand circular polarization and (ii) left-hand circular polarization wavelengths to right-hand circular polarization. In this exemplary embodiment or another exemplary embodiment, the present disclosure may provide a spatially varied orientation of the phase material and polarization evolution adapted control wavefront shape of incoming wavelengths. In this exemplary embodiment or another exemplary embodiment, the present disclosure may provide a uniform thickness of the phase material having spatially varied orientation throughout the uniform thickness.

In yet another aspect, an exemplary embodiment of the present disclosure may provide a shearography method comprising: illuminating a surface with electromagnetic radiation; receiving returned electromagnetic radiation from the surface; transmitting the returned electromagnetic radiation through a first optical element formed from a geometric phase material; outputting the returned electromagnetic radiation from the first optical element at a first circular polarization; transmitting the returned electromagnetic radiation at the first circular polarization through an opposite second optical element formed from a geometric phase material that is oriented from 0° to 180° relative to the first optical element; and linearly polarizing the transmitted electromagnetic radiation. In one embodiment the second optical element formed from a geometric phase material that is oriented 180° relative to the first optical element. This exemplary method or another exemplary method may further comprise outputting electromagnetic radiation from the second optical in parallel beams towards a linear polarizer; and polarizing, via the linear polarizer, the parallel beams of electromagnetic radiation output from the second optical element. This exemplary method or another exemplary method may further comprise outputting electromagnetic radiation from the second optical in parallel beams towards a focal plane array with micropatterned linear polarizers of multiple orientations; polarizing, via the linear polarizer, the parallel beams of electromagnetic radiation output from the second optical element; and recording an instantaneous plurality of phase-shifted specklegrams.

In yet another aspect, an exemplary embodiment of the present disclosure provides a shearography system uses an optical phenomenon called Geometric phase or Pancharatnam-Berry (PB) phase element to shear an image. A geometric phase element provides a non-dynamical phase change that can be used for wavefront control and results in uniform half-wave of retardation. Geometric phase may also be utilized to capture snapshot phase-resolved wavefront measurements and shearograms through the use of a focal plane array with micro-patterned linear polarizers of different orientations. Wavefront shape control arises when the local orientation of the retarding media is spatially varied. One or more PB phase elements can be flipped or rotated to allow the same optical element design to perform multiple tasks depending on its orientation. In the case of shearography, two PB elements can be used in succession in order to provide a variable purely spatial shift between interfering wavefronts. The spatial offset of the light exiting the second element can be adjusted simply by changing the spacing between the two geometric phase surfaces. In shearography, this corresponds to an adjustable shear length. Alternative methods to change shear include rotating two PB grating elements about the optical axis in a configuration similar to a Risley prism pair, using individual PB elements with fixed shear angles and swapping them out, or making a stack of PB elements out of a switchable spatially patterned birefringent material or spatially patterned waveplate material.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a schematic operational view of an exemplary shearography system according to one aspect of the present disclosure.

FIG. 2 is a diagrammatic operational view of the shearography system according to an aspect of the present disclosure.

FIG. 3 is a perspective view of a geometric phase optical element used within the shearography system shown in FIG. 1.

FIG. 4 is a partial cross section view taken along line 4-4 in FIG. 3 depicting a spatially patterned birefringent material or spatially patterned waveplate layer in the geometric phase optical element.

FIG. 5 is a schematic operational view of two geometric phase optical elements within the shearography system of FIG. 1.

FIG. 6 is a flow chart depicting an exemplary method according to one exemplary aspect of the present disclosure.

Similar numbers refer to similar parts throughout the drawings.

### DETAILED DESCRIPTION

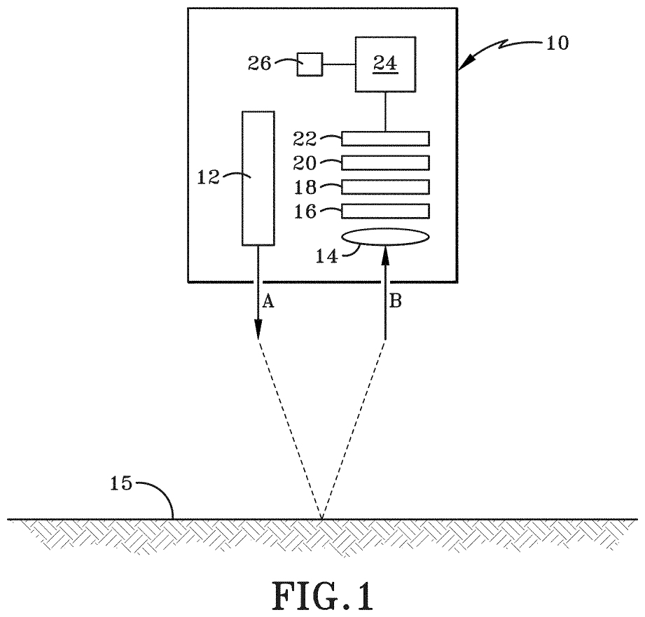

FIG. 1 depicts an exemplary shearography system of the present disclosure generally at 10. Shearography system 10 includes one or more laser transmitters 12, (which generally may be referred to as a “device” or “devices” in the appended claims), a lens 14, a first optical element 16, a second optical element 18, a linear polarizer 20, a sensor or focal plane array 22, and shearography logic 24 coupled to the sensor 22. In the basic operation of shearography system 10, one of the one or more laser transmitters 12 transmits, emits a laser beam (Arrow A in FIG. 1) which impacts a target surface or target area 15 and is reflected from area 15 as a reflected laser-illuminated image (Arrow B in FIG. 1) back to system 10 into lens 14 which focus the beam on the first optical element 16 and is then transmitted to the second optical element 18. From the second optical element 18, the beams are transmitted to the linear polarizer 20 and are then sensed by sensor 22. Shearography logic 24 is coupled to sensor 22 to process the information contained in the beams. The reflected laser beam generates image data as specklegrams that are collected and stored or saved in the at least one non-transitory computer readable storage medium 26. Logic 24 processes the specklegrams to produce a shearogram from which can be discerned surface changes of target surface 15 and corresponding subsurface structures or movements as well as calculate the various relevant equations discussed below in order to effect the methods discussed herein.

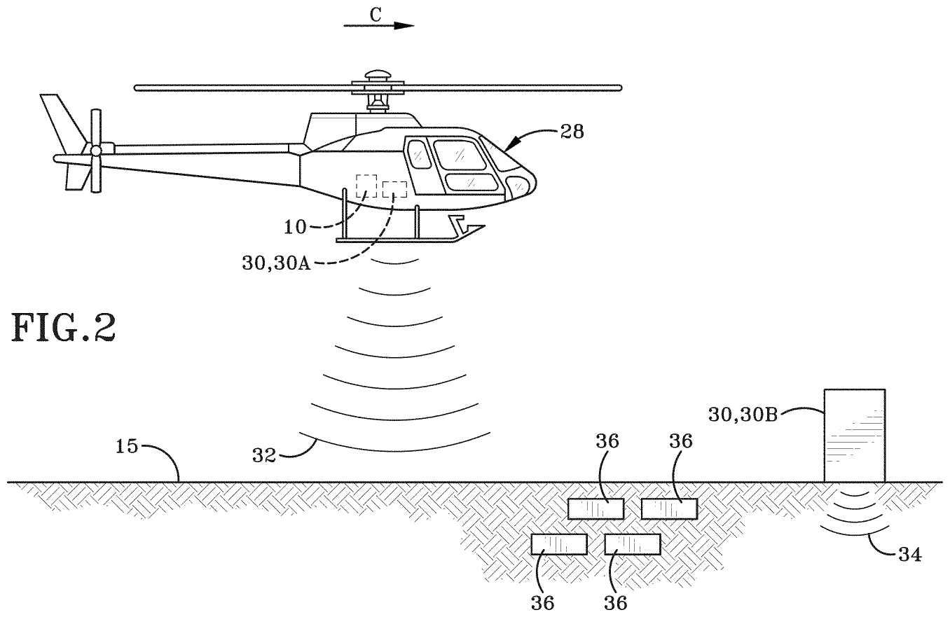

FIG. 2 depicts the shearography system 10 mounted on a moveable platform 28, which may include powered transport or vehicles such as aircraft, watercraft (surface craft or underwater craft), spacecraft or land motor vehicles which may be manned or unmanned, whereby, for instance, an aircraft may be a manned/piloted aircraft or an unmanned aerial vehicle (UAV). The moveable platform 28 may also be a handheld device which may move as a result of being carried by a person who is moving (under his or her own power or via a powered vehicle) or by being carried by one of the other moveable platforms noted above. For purposes of example, moveable platform 28 is shown as a helicopter carrying the shearography system 10. The system 10 moves with moveable platform 28 relative to a target or target surface 15 during operation of system 10. This movement of moveable platform 28 and system 10 is shown at Arrow “C” in FIG. 2, which also represents the forward direction of movement or flight of the moveable platform 28. The movement of the moveable platform 28 and system 20 during the emission of laser beams from lasers 2 and collection of specklegrams is typically generally parallel to the target surface 15 or ground.

A target excitation device 30 is provided to non-destructively deform or load target 15. The target excitation device 30 may be an onboard excitation device 30A (FIG. 2) mounted on the moveable platform 28 or may be a separate excitation device 30B (FIG. 2) which is separate from or not on the moveable platform 14. The target excitation device 30A may be, for instance, a sound driver or acoustic source or speaker capable of producing or emitting sound waves 32 (FIG. 2). For example, the target excitation device 30A may emit a relatively high power, low frequency sound wave which is directed from the moveable platform 28 or system 10 toward the ground or other target surface 15 to vibrate (deform or load) the ground or other target surface 15. Separate target excitation device 30B may be, for example, a seismic thumper which may be in the form of a thumper truck, which may also be known as a vibroseis truck or vibe truck. A seismic thumper impacts or is directed toward the ground or other target surface 15 to likewise vibrate (deform or load) the ground or other target surface 15, as illustrated by waves or vibrations 34 (FIG. 2). The use of shearography system 10 allows for the discernment of underground anomalies 36 (FIG. 2) such as underground ordnance or landmines (including improvised explosive devices or IED) or other subsurface or underground objects or structures such as rooms, tunnels, pipes and so forth.

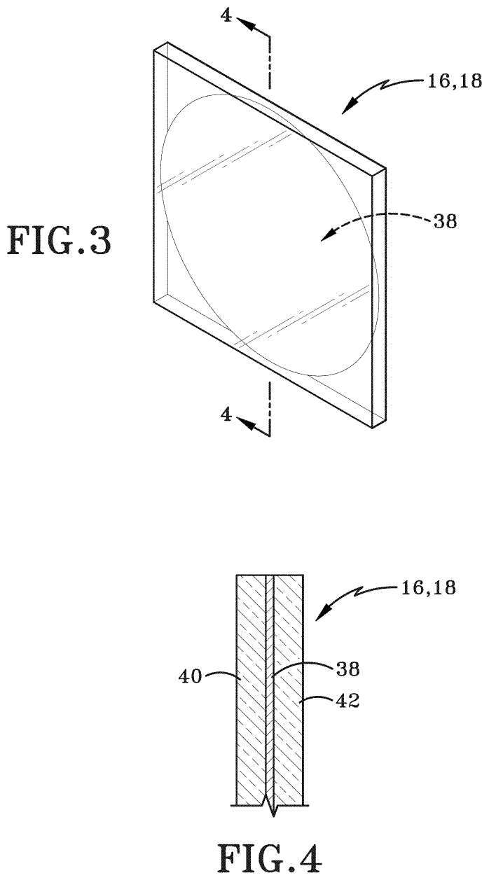

FIG. 3 depicts an exemplary optical element that may be used as the first optical element 16 and the second optical element 18 in system 10 of the present disclosure. Stated otherwise, the first optical element 16 and the second optical element 18 are formed identically within the shearography system 10. Each optical element 16,18 may be a geometric phase optical element which is also known as a Pancharatnam-Berry (PB) phase optical element in order to shear the image moving through the first and second optical elements 16,18. An exemplary PB optical element may have a gradient that is optimized for light wavelength of 500 nanometers. The PB optical elements 16,18 provide a solution for self-referencing computational shear. PB optical elements are commercially available and they are known to split polarized light evenly between right hand circular polarization (RCP) and left hand circular polarization (LCP) outputs.

FIG. 4 depicts that the PB optical elements 16,18 each has a spatially patterned birefringent material or spatially patterned waveplate layer 38 that is enveloped between a first optical medium 40 and a second optical medium 42. The spatially patterned birefringent material or spatially patterned waveplate layer of 38 between the optical mediums 40,42 has a patterned orientation that results in the diffraction angle to split the outputs as the wavefronts move through the PB optical element. The layer 38 within the optical elements 16, 18 may be considered as a phase material. Thus the layer 38 in the first optical element 16 may be referred to as a first phase material and the layer 38 in the second optical element 18 may be referred to as a second phase material. While layer 38 is described herein as a spatially patterned birefringent material or spatially patterned waveplate layer, other phase materials that split the outputs into RCP and LCP will suffice.

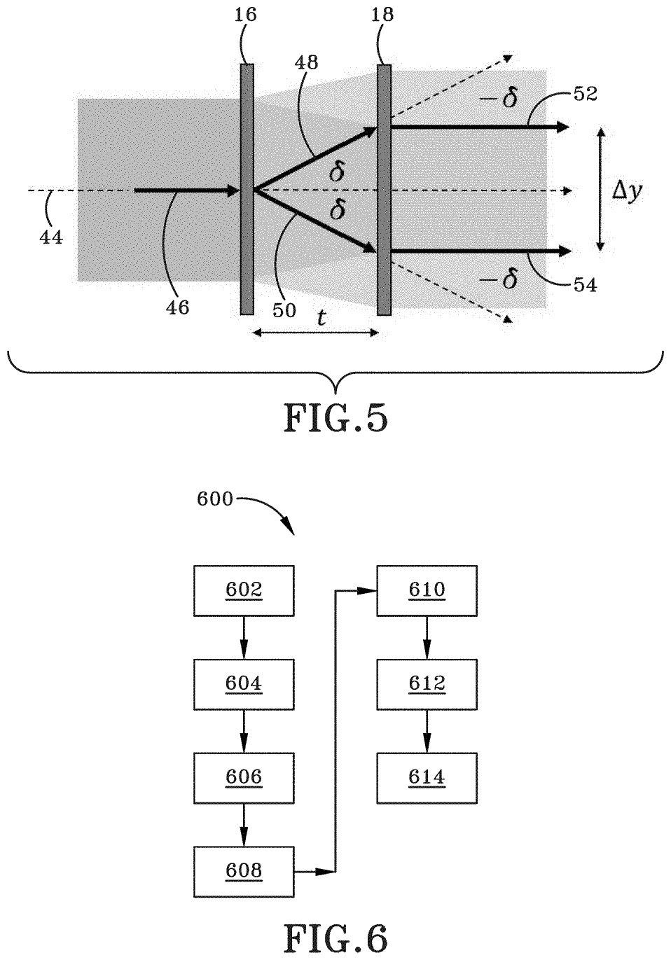

Each PB optical element 16,18 includes a geometric phase element coating enveloped between two transparent mediums 40,42 such as optical glass. The phase element may be a spatially patterned birefringent material or spatially patterned waveplate material between two slides of optical glass. At the output of the first geometric element 16, there is a fixed angular shear. Notably, of the second element of the present disclosure is offset (shown in FIG. 5) of the first geometric phase element, another optical plane device or PB element may be offset from the output of the first geometric phase element. The planar configuration of a secondary device would detect the two output beams from the first geometric phase element.

With continued reference to FIG. 3 and FIG. 4, a geometric phase optical material of optical elements 16,18 is shear an image in shearography system 10 by interfering wavefronts originating from points that are spatially separated on surface 15 by a shear length. The wavefronts undergo a geometric phase shift proportional to a diffraction angle during polarization transformation. The geometric phase optical material of optical elements 16,18 has a uniform half-wave retardation of wavelengths incoming to the phase material. As a result, there is a polarization shift effectuated by the uniform half-wave retardation of wavelengths. The polarization shift switch one of (i) right-hand circular polarization wavelengths to left-hand circular polarization and (ii) left-hand circular polarization wavelengths to right-hand circular polarization. The spatially varied orientation of the phase material and polarization evolution enables system 10, and more particularly, logic 26, to control wavefront shape of incoming wavelengths. The layer 38 of the geometric phase material may have a uniform thickness of the phase material having spatially varied orientation throughout the uniform thickness. In some instances, the uniform thickness is in a range from about 1 micron to about 20 microns thick.

FIG. 5 schematically depicts the PB optical element 16 and the PB optical element 18 in a configuration for operation. The PB optical element 16 and the PB optical element 18 are aligned along an optical axis 44. However, the second optical element 18 is rotated 180 degrees about the optical axis relative to the first optical element 16. The first optical element 16 is spaced from the second optical element 18 by a distance t. In operation and with reference to FIG. 5, wavefronts 46 entering element 16, after having been focused by lens 14 along with optical axis 44, move towards the frontal surface of the first optical element 16. wavefront 46 moves through the first optical element 16 where the spatially patterned birefringent material or spatially patterned waveplate layer 38 splits the wavefront 46 into a first output 48 and a second output 50. First output 48 is RCP polarization and the second output 50 is LCP polarization. The outputs 48,50 are separated from the optical axis 44 by a diffraction angle δ. The distance t may be controlled by spatial offset logic configured to adjust the spatial offset of the RCP and LCP. The spatial offset logic may be part of logic 26 or may be its own standalone logic. The spatial offset logic may alter distance t between the first phase material in element 16 and the second phase material in element 18 to provide an adjustable shear length

The second optical element 18 is rotated 180 degrees relative to the optical axis 44 such that when the first output 48 from the first optical element 16 enters the second optical element 18, the rotated spatially patterned birefringent material or spatially patterned waveplate layer 38 within the second optical element 18 alters the RCP from output 48 into LCP output 52. The second optical element 18 has an exit surface, wherein the RCP and LCP wavelength outputs 52, 54 exit the exit surface. The rotation of the second optical element relative to the optical axis 44 causes the diffraction angle δ to be negated such that the output 52 from the second optical element 18 is offset parallel from the optical axis 44. Similarly, when the LCP output 50 from the first optical element 16 enters the second optical element 18, the rotation of the spatially patterned birefringent material or spatially patterned waveplate layer 38 in the second optical element 18 causes the diffraction angle δ to be negated that results in an output 54 from the second optical element 18 that is offset parallel to the optical axis 44 and has an opposing RCP polarization of output 54. The outputs 52,54 are offset a distance from each other parallel to the optical axis 44 and the spacing distance is represented by Δy. Subsequent to the outputs 52,54 is the linear polarizer 20. The outputs 52,54 are sent to the linear polarizer 20 for linear polarization. The output from the linear polarizer 20 may then be sensed by the image sensor or FPA 22. By orienting the second geometric phase optical element 18 180° relative to the first geometric phase element 16, the output beams 52, 54 are split in the reverse direction that results in two parallel output beams parallel with the original optical axis 44.

Having thus described the general configuration of system 10 using geometric optical phase elements 16, 18 arranged in this configuration as being rotated 180° relative to each other, reference is now made to its exemplary advantages and further operations. In accordance with one aspect of the present disclosure, the system 10 includes two geometric phase optical elements 16, 18 or flat thin phase elements that are geometric phase elements. One of the geometric phase elements is flipped 180 degrees around so that incoming light or wavefronts is split into two parts (i.e., outputs 48, 50) by the first geometric phase element 16 at a set diffraction angle δ. The second PB optical element 18 will undo the flipped light output wavefronts 48, 50 at the same angle. As previously described, the first PB optical element 16 splits the light or wavefronts 46 into RCP and LCP outputs 48, 50. The second geometric phase element 18 will respectively add the opposite polarization tilts to the light passing therethrough. With respect to the RCP and the LCP, the second geometric phase element 18 being rotated 180 degrees relative to the first element creates a parallel offset spacing of the light output from the second geometric phase element 18. Spacing distance t between the two phase elements depends on the divergence of the output light from the first phase element. Stated otherwise, the diffraction angle δ of the output light from the first geometric phase element 16 is a constant that must be taken into account by the separation distance t between the second geometric phase element and the first geometric phase element. For example, if the diffraction angle δ is smaller, such as one degree, then the spacing between the first and second geometric phase elements 16, 18 may be on the order of millimeters or centimeters. However, it is a larger diffraction angle δ than the spacing distance between the first and second geometric phase elements may be on the order of a few nanometers.

Generally, shearography uses an interferometer having been illuminated with a radiation source to detect changes in the surface of the material, typically a very narrow waveband source is used, such as a laser, to perform the illumination. In one exemplary embodiment, system 10 illuminates an area of interest on surface 15 with a laser 12 because the laser is spatially and temporally coherent. As such, it will provide clean interference patterns. Thus, the surface 15 is illuminated with a laser and it reflects the laser back towards a receiver (as shown by Arrow B in FIG. 1). The light reflected from the surface comes off as speckled as it interferes with itself from the surface. Thus, the incoming light to the receiver (which is collective defined by 14, 16, 18, 20, and 22) has speckle fields for processing in the form of an interferometer. The interferometer of shearography system 10 is able to detect the interference of the speckle fields with itself. Then, lens 14 forms an image through optical elements 16, 18 and linear polarizer for sensing via sensor 22. The image, or specklegram, is two overlapping speckle fields that are sheared that is shifted laterally. This creates an interference between one point in a first specklegram with a second point in the second specklegram. Thus if the surface is deformed, the change of the surface becomes evident in a change in the specklegrams which is then visualized in generating a shearogram. Stated otherwise, a surface change will create a change in the speckle pattern that can be viewed through the sensor to determine or detect the change of the surface.

When coherent light hits a phase mapped surface 15, such as a rough surface or changes in refractive index, the coherent light will be warped or changed into an outgoing wavefront that can interfere with itself. This results in speckle. Thus, if the surface has changed, it alters the speckle pattern. Because the speckle pattern is coherent, it will interfere with itself and carries detectable phase information. The system of the present disclosure is able to take the difference between the first specklegram and a specklegram to obtain the difference in the two specklegrams which is able to provide the difference in phase of the surface defamation. Thus, the system of the present disclosure is self-referential interferometry.

In operation, the system 10 of the present disclosure enables the receiver to take a first specklegram image as a reference and take a second, perturbed specklegram image to measure a change in the material. The interferometer logic 26 of the present disclosure may also enable phase resolved (PR) operation where a uniform phase shift is applied to one of the sheared wavefronts relative to the other, and phase-sensitive information of the specklegram is recorded in the change intensity of the speckle given the uniform phase shift. Phase shifts may be applied by a piezo-actuated mirror in one light path if the interfering wavefronts are spatially separated and recombined, or by rotating the linear polarizer after the GP interferometer. The recent introduction of micro-polarizer patterned focal plane arrays allow for simultaneous measurement of phase shifts for each polarizer angle patterned onto the sensor, in such an application the GP element shearing interferometer would be placed in front of the micropolarizer camera and gather snapshot phase maps of the specklegram, enabling a compact (two-shot, temporally) phase resolved shearing interferometer.

Common challenges with shearography systems to date depend on the size, weight, fabrication difficulty, and field-of-view limitations of traditional interferometers such as the Michelson or Mach-Zehnder. These common interferometers typically employ cube beamsplitters and sturdy optical benches in order to enable shearography in common environments with a useful field of view. Another traditional limitation relates to phase-stepping. To accomplish a phase in one of the interferometer paths, one or more mirrors must be moved in and out relative to the optical axis in fractions of a wave. This requires control of the mirror's position to the nanometer level which is difficult to accomplish due to its high precision and imposes significant engineering challenges for operating in vibration-heavy environments. Polarization phase stepping removes the complexity of a piezo mirror, but is still limited to large breadboards, limited fields of view, and multiple beamsplitters.

The present disclosure overcomes these problems of traditional interferometers by removing the need for mirrors and one or more passes through a beamsplitter and instead uses thin geometric phase optical elements 16, 18. The geometric phase optical elements may be any type of optical element that introduces a geometric phase shift. One exemplary geometric phase optical element that provides the exemplary advantages described herein is a Pancharatnam-Berry optical element (PBOE). The PBOE takes advantage of the Pancharatnam-Berry phase that is accumulated over gradually varying the polarization state of light by a half wave of retardation, where local changes to the orientation of the half wave of retardation shape the phase map of the wavefront passing through the PBOE and separate the LCP and RCP components of the input light into separate, conjugate wavefronts.

Geometric phase, as used herein may also be referred to as Pancharatnam-Berry phase, Geometrical Phase, Topological Phase, and Optical Adiabatic Phase. Applications of this phase are seen in Pancaratnam-Berry Optical Elements (PBOE), also called Cycloidal Diffractive Waveplates (CDW), polarization gratings, geometric phase optical elements.

In one exemplary embodiment, the PBOE (i.e., optical elements 16, 18) of the present disclosure has a birefringent layer 38, which is a flat planar and thin configuration enveloped between two layers of optical glass 40, 42. The birefringent layer of the PBOE does not have equal refractive indices in all directions. Stated otherwise, the birefringent media has non-uniform optic axis. The PBOE may be comprised of a plurality of stacked patterned wave plates. The present disclosure uses the PBOE optical elements to enable varying wavefront shear in a highly customizable and compact form.

In one exemplary embodiment of GP shearography, there needs to be at least two GP elements and a linear polarizer. The first optical element 16 is oriented at a normal position and the second optical element 18 is flipped or rotated 180 degrees relative to the first optical element. As discussed herein, the two elements are the geometric phase elements or PBOEs. By flipping the second optical element 180 degrees relative to the optical axis and relative to the first element causes the light that is split into two opposite-handed circular polarization components by the first optical element to be reverted or the second optical element undoes the splitting diffraction angle δ at an equal but opposite diffraction angle −δ to result in two output parallel beams 52, 54. The first optical element splits the outputs into respective right hand circular and left hand circular polarizations. The second optical element reverses the polarization such that the incoming light at a right hand circular polarization into the second element is then changed to left hand circular polarization output from the second optical element. Similarly, left hand circular polarization light that is input into the second optical element is switched to right hand circular polarization output from the second optical element.

Changes to the shear length, direction, and distribution across the system field of view tunes the sensitivity of the system to spatial changes on the measurement surface. Control of the shear parameters allows for measurement at different sensitivities to speckle field changes to be viewed through the system of the present disclosure.

Shear in the images is the separation between two superimposed copies of an image. There may be lateral shear and radial shear. Lateral shear is an image split into two parts and separated by a uniform spatial shift between the copies of the image, Radial shear is when the images enlarged or shrunk relative to a common point between the two images and the shear represents a radial increase or radial decrease between the same two points between the two images. As such, shear encompasses the distance between equal points on two shifted, rotated, scaled, or otherwise deterministically transformed images.

Another exemplary property exhibited by the system 10 of the present disclosure is that when the first PB element splits the light beam into two polarization components at a diffraction angle δ and the second element reverts the tilt of the light beams at a second equal but opposite diffraction angle −δ so that because the output of the second element are parallel there is a fixed spatial shear for any object or image distance. This is different from a typical shearography system in which one of the prior art mirrors is tilted, there is the same effect of only a single element of the present disclosure. Thus, if there was a measurement plane at different distances relative to a prior art Michelson-type shearography system, it views different separations depending on the location of the measurement plane. However, in accordance with the present disclosure, the parallel output from the second optical element enables the measurement plane of sensor 22 to be placed at any distance relative to the second optical element to obtain the measurement which is beneficial to observe objects at different distances such that the system will ensure that same shear is obtained regardless of the distance of the measurement plane from the second optical element.

The measurement plane (i.e., sensor 22) which may be a focal plane array (FPA), measures both outputs 52, 54 from the second optical element. Thus, while schematically the output beams are shown as parallel, for the interferometry to fully operate the sheared wavefronts must overlap. In the overlapping area is where the two output beams interfere with each other. The overlapping area provides the use of wavefront phase information to accomplish the interferometry of the present disclosure. The overlapping area is sensed by the optical sensor or the plane measurement device.

The linear polarizer 20 is a device that effectuates the interferometry measurement of the present disclosure. By using the first geometric phase element 16, the incoming light is split into two different polarization states that are orthogonal. In order for the light to interfere with each other, the two light components output have to have the same polarization state. By putting a linear polarizer optically after of the PB optical elements 16, 18, it blocks all but one polarization state, sending out linear equal polarizations separated from each circularly polarized input. The linear polarizer's rotational orientation is additionally effective for phase stepping. For effective phase stepping, the linear polarizer may be rotated by angle θ that will shift the relative phase φ between the two interfering output beams 52, 54 by 2θ.

In some implementations, the linear polarizer 20 is a spinning linear polarizer or the linear polarizer is a micro-pattern polarizer sensor. The micro-pattern polarizer sensors have polarization patterns oriented in different directions for each pixel and that is copied over the full focal plane. Thus, for any image that is taken, multiple polarization states are seen. With respect to the present disclosure, if this type of linear polarizer is placed behind the second geometric phase element, it provides a snapshot of phase measurement by taking four polarization angles. This is distinct from the prior art interferometers that require four separate shots or images each with a different phase step on the piezo chip. The number of phase measurements may also be three or more than four. The linear polarizer angle corresponds directly to a specific phase shift. Thus, once the polarizer orientation is taken into account, similar traditional interferometer processing, via logic 26, can occur to determine the phase of the shearogram.

Geometric Phase may be used for phase-stepping. In phase stepping, The electric field vector ε can be represented as a superposition as two orthogonal linear polarization states εₓ and ε_{y}. A phase shift of 90° between the two axes results in an electric field vector that traces a circle over time, where the direction of the phase shift (±90°) dictates whether the light is LCP or RCP. Wherein,

$$\begin{matrix}ɛ ( z , t ) = {ɛ}_{x} \hat{x} + {ɛ}_{y} \hat{y} & ( 3 ) \\ {ɛ}_{x} = {a}_{x} cos [ ω ( t - \frac{z}{c} ) + {ϕ}_{x} ] & ( 4 ) \\ {ɛ}_{y} = {a}_{y} cos [ ω ( t - \frac{z}{c} ) + {ϕ}_{y} ] & ( 5 )\end{matrix}$$

A linear polarizer oriented with its wire grid in the x direction will block the ε_{y} component of ε and vice-versa.

Modifications to the polarization state of light can be modeled using Jones matrices:

$$\begin{matrix}{J}_{2} = {T}^{′} {J}_{1} & ( 6 ) \\ {J}_{1} = [ \begin{matrix}{A}_{1 x} \\ {A}_{1 y}\end{matrix} ] , \\ {J}_{1 , RCP} = \frac{1}{\sqrt{2}} [ \begin{matrix}1 \\ j\end{matrix} ] , \\ {J}_{1 LCP} = \frac{1}{\sqrt{2}} [ \begin{matrix}1 \\ - j\end{matrix} ] & ( 7 ) \\ T = [ \begin{matrix}1 & 0 \\ 0 & 0\end{matrix} ] ( linear polarizer , along x ) & ( 8 ) \\ R ( θ ) = [ \begin{matrix} cos θ & sin θ \\ - sin θ & cos θ\end{matrix} ] & ( 9 ) \\ {T}^{′} = R ( θ ) T R ( - θ ) & ( 10 )\end{matrix}$$

For Anisotropic media and polarization, the orientation of a linear polarizer can introduce a geometric phase shift between incident RCP and LCP waves. Additionally the orientation of a half-wave plate will rotate the orientation of incoming polarization states by 2θ where θ is the rotation angle of the HWP. The resulting output of the HWP will be a change in handedness for CP light and accumulation of GP based on the orientation of the HWP. The GP or PB optical elements 16, 18 may use micro-patterned HWPs with different local orientations in order to generate a geometric phase profile. The LCP and RCP inputs are diffracted into opposite orders at the output of the GP element. Much like the linear polarizer case, Jones Matrices can be used to find the geometric phase changes due to HWP orientation. Wherein,

$$\begin{matrix}{J}_{2} = {TJ}_{1} & ( 11 ) \\ [ \begin{matrix}{A}_{2 x} \\ {A}_{2 y}\end{matrix} ] = [ \begin{matrix}{T}_{11} & {T}_{12} \\ {T}_{21} & {T}_{22}\end{matrix} ] [ \begin{matrix}{A}_{1 x} \\ {A}_{1 y}\end{matrix} ] & ( 12 ) \\ {T}_{WP} = [ \begin{matrix}1 & 0 \\ 0 & {e}^{- i Γ}\end{matrix} ] & ( 13 )\end{matrix}$$

where Γ is a phase delay of the waveplate,

$${T}_{HWP} ( θ ) = R ( θ ) [ \begin{matrix}1 & 0 \\ 0 & {e}^{- i π}\end{matrix} ] R ( - θ ) = [ \begin{matrix}{cos}^{2} θ - {sin}^{2} θ & 2 cos θsinθ \\ 2 cos θsinθ & {sin}^{2} θ - {cos}^{2} θ\end{matrix} ] \qquad ( 14 )$$

After each HWP, the handedness of the circular polarization will flip. For PBOEs, the HWP orientation angle θ is a function of x and y, so the phase delay φ=2 is also a function of x and y. Many HWP layers can be stacked to achieve large φ values.

For wavefront shaping in the HWP, the following formulas are used for finding the output Jones vectors of LCP and RCP respectively for orientation angle θ for each x,y coordinate and the accumulated geometric phase φ.

$$\begin{matrix}{J}_{RCP}^{′} ( θ ) = T \frac{1}{\sqrt{2}} ( \begin{matrix}1 \\ i\end{matrix} ) & ( 15 ) \\ T = [ \begin{matrix}{cos}^{2} θ - {sin}^{2} θ & 2 cos θsinθ \\ 2 cos θsinθ & {sin}^{2} θ - {cos}^{2} θ\end{matrix} ] & ( 16 ) \\ {J}_{RCP}^{′} ( θ ) = [ \begin{matrix}{cos}^{2} θ - {sin}^{2} θ & 2 cos θsinθ \\ 2 cos θsinθ & {sin}^{2} θ - {cos}^{2} θ\end{matrix} ] \frac{1}{\sqrt{2}} ( \begin{matrix}1 \\ i\end{matrix} ) & ( 17 ) \\ {J}_{RCP}^{′} ( θ ) = \frac{1}{\sqrt{2}} ( \begin{matrix}{cos}^{2} θ - 2 i cos θsinθ - {sin}^{2} θ \\ - 2 cos θsinθ - i {cos}^{2} θ + i {sin}^{2} θ\end{matrix} ) & ( 18 ) \\ {J}_{RCP}^{′} ( θ ) = \frac{1}{\sqrt{2}} ( \begin{matrix}cos ( 2 θ ) - i sin ( 2 θ ) \\ - sin ( 2 θ ) - i cos ( 2 θ )\end{matrix} ) & ( 19 ) \\ {J}_{RCP}^{′} ( θ ) = \frac{1}{\sqrt{2}} ( \begin{matrix}cos ϕ - i sin ϕ \\ - s in ϕ - i cos ϕ\end{matrix} ) & ( 20 ) \\ {J}_{RCP}^{′} ( θ ) = \frac{1}{\sqrt{2}} ( \begin{matrix}{e}^{- i ϕ} \\ - i {e}^{- i ϕ}\end{matrix} ) & ( 21 ) \\ {J}_{RCP}^{′} ( θ ) = \frac{{e}^{- i ϕ}}{\sqrt{2}} ( \begin{matrix}1 \\ - i\end{matrix} ) = {e}^{- i ϕ} {J}_{LCP} & ( 22 )\end{matrix}$$

The output is LCP with ϕ=2θ phase shift

$${J}_{LCP}^{′} ( θ ) = \frac{{e}^{i ϕ}}{\sqrt{2}} ( \begin{matrix}1 \\ i\end{matrix} ) = {e}^{i ϕ} {J}_{RCP} \qquad ( 23 )$$

Φ=±ϕ, where RCP and LCP have opposite phase shifts of ±ϕ or ±2θ

Patterning ±ϕ as a function of x and y allows for the separation of LCP and RCP wavefronts, enabling image shear. Adding a linear polarizer after the GP element allows for interference of the sheared LCP and RCP wavefronts and enables its use in shearography.

For phase stepping in the linear polarizer, the following formulas are used for LCP and RCP inputs respectively to find geometric phase shift φ.

$$\begin{matrix}{J}_{RCP}^{′} ( θ ) = R ( θ ) [ \begin{matrix}1 & 0 \\ 0 & 0\end{matrix} ] R ( - θ ) \frac{1}{\sqrt{2}} ( \begin{matrix}1 \\ i\end{matrix} ) & ( 24 ) \\ {J}_{RCP}^{′} ( θ ) = [ \begin{matrix}{cos}^{2} θ & sin θcos θ \\ sin θcos θ & {sin}^{2} θ\end{matrix} ] \frac{1}{\sqrt{2}} ( \begin{matrix}1 \\ i\end{matrix} ) & ( 25 ) \\ {J}_{RCP}^{′} ( θ ) = \frac{1}{\sqrt{2}} ( \begin{matrix}( {cos}^{2} θ + i sin θcos θ ) \\ ( sin θ cos θ + i {sin}^{2} θ )\end{matrix} ) & ( 26 ) \\ {J}_{RCP}^{′} ( θ ) = \frac{1}{\sqrt{2}} ( \begin{matrix}cos θ {e}^{i θ} \\ sin θ {e}^{i θ}\end{matrix} ) & ( 27 ) \\ {J}_{RCP}^{′} ( θ ) = \frac{1}{2 \sqrt{2}} ( \begin{matrix}{e}^{i 2 θ} \\ {e}^{i 2 θ}\end{matrix} ) & ( 28 ) \\ {J}_{RCP}^{′} ( θ ) = \frac{{e}^{i 2 θ}}{2 \sqrt{2}} ( \begin{matrix}{A}_{x} \\ {A}_{y}\end{matrix} ) & ( 29 ) \\ {J}_{LCP}^{′} ( θ ) = \frac{{e}^{- i 2 θ}}{2 \sqrt{2}} ( \begin{matrix}{A}_{x} \\ - {A}_{y}\end{matrix} ) & ( 30 )\end{matrix}$$

Both LCP and RCP inputs exit as linear polarization with a relative phase shift of ±2θ while losing ½ of the magnitude of the input amplitudes.

ϕ=2θ (31)

In applying the system 10 to shearography, Interferometer designs require the combination of two coherent wavefronts. If the two wavefronts are sufficiently coherent, they will produce interference fringes. In interferometry based on dynamic phase measurement, measurements with different phase offsets between the beams are required in order to calculate the phase map. The Polarization-based interferometers of the present disclosure require an additional waveplate (QWP) and linear polarizer as orthogonal polarization states don't interfere. Geometric phase elements split light by the handedness of the optical spin (LHC, RHC) and only require a single linear polarizer at the output to produce interferograms. This linear polarizer 22 can also act as a phase shifter based on its rotation. Snapshot phase measurements can be made by using an image sensor with polarizers micropatterned with different orientations within a superpixel.

FIG. 6 depicts an exemplary method for shearography system 10 generally at 600. Method 600 includes illuminating surface 15 with electromagnetic radiation, which is shown generally at 602. Method 600 includes receiving the returned electromagnetic radiation from the surface in the shearography system, which is shown generally at 604. Method 600 includes transmitting the returned electromagnetic radiation through the first optical element 16 formed from a geometric phase material or having layer 38, which is shown generally at 606. Method 600 includes outputting the returned electromagnetic radiation from the first optical element 16 at a first circular polarization, which is shown generally at 608.

As described herein, at 608, the first optical element splits the output beams 48, 50 of electromagnetic radiation, via layer 38, into RCP and LCP separated by the diffraction angle δ. The distance that beams 48, 50 travel depends on the distance t that separates the first optical element 16 from the second optical element 18. Method 600 includes transmitting the beams 48, at their respective first circular polarization (either RCP or LCP) through the second optical element 18 formed from a geometric phase material that is oriented 180° relative to the first optical element, which is shown generally at 610. Thus, the second optical element may be referred to as an opposite second element, wherein “opposite” refers to being oriented 180 degrees relative to the optical axis 44 even though the physical formation of the second element is identical to the first element. The beams 52, 54 of output by the second optical element 18 are parallel towards the linear polarizer, which is shown generally at 612. Then, method 600, polarizes, via the linear polarizer, the parallel beams 52, 54 of electromagnetic radiation output from the second optical element, which is shown generally at 614.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When portions are implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A shearography system comprising:
a first phase material that is either a geometric phase material or Pancharatnam-Berry (PB) phase material;
a second phase material that is either a geometric phase or PB phase material, wherein the second phase material is optically subsequent to the first material; and
a first polarization orientation of the first phase material and a different second polarization orientation of the second phase material adapted generate a spatial shift in wavelengths moving through the first phase material and the second phase material adapted to allow for a common linear polarization state to allow for interference between wavelengths.

2. The shearography system of claim 1, further comprising:
a linear polarizer optically subsequent to the second phase material; and
a sensor optically subsequent to the linear polarizer.

3. The shearography system of claim 1, further comprising:
a constant separation angle between right-hand circular polarization (RCP) wavelengths and left-hand circular polarization (LCP) wavelengths separated by the first phase material;
wherein the second phase material is oriented to negate the constant separation angle.

4. The shearography system of claim 3, further comprising:
an exit surface of the second phase material, wherein the RCP and LCP wavefronts exit the exit surface.

5. The shearography system of claim 4, further comprising:
spatial offset logic configured to adjust the spatial offset of the RCP and LCP wavefronts exiting the exit surface.

6. The shearography system of claim 4, wherein the spatial offset logic alters a distance between the first material and the second material that is adapted to provide an adjustable shear length.

7. The shearography system of claim 4, wherein the rotational offset logic alters an orientation angle between the first material and the second material that is adapted to provide an adjustable shear length.

8. The shearography system of claim 1, further comprising:
a constant separation angle between right-hand circular polarization (RCP) wavelengths and left-hand circular polarization (LCP) wavelengths separated by the first phase material;
wherein the second material is oriented as having been rotated 180° relative to the first material to double the constant separation angle.

9. The shearography system of claim 1, wherein both the first phase material and the second phase material are formed from a birefringent material.

10. The shearography system of claim 1, wherein the first and second phase elements interfere with wavefronts originating form points on a target that are spatially separated by a shear length.

11. A shearing element for a shearography system with an adjustable shear, the shearing element comprising:
a geometric phase optical material to shear an image by interfering with wavefronts originating from points that are spatially separated on a surface by a shear length; wherein wavefronts undergo a geometric phase shift proportional to a diffraction angle after polarization transformation.

12. The shearing element of claim 11, wherein the geometric phase optical material is a Pancharatnam-Berry (PB) phase material comprising a uniform half-wave retardation of wavelengths incoming to the phase material; and
a polarization shift effectuated by the uniform half-wave retardation of wavelengths, wherein the polarization shift switch one of (i) right-hand circular polarization wavelengths to left-hand circular polarization and (ii) left-hand circular polarization wavelengths to right-hand circular polarization.

13. The shearing element of claim 11, further comprising:
a spatially varied orientation of the phase material and polarization evolution adapted control wavefront shape of incoming wavelengths.

14. The shearing element of claim 13, further comprising:
a uniform thickness of the phase material having spatially varied orientation throughout the uniform thickness.

15. The shearing element of claim 14, wherein the uniform thickness is in a range from about 1 micron to about 20 microns thick.

16. The shearing element of claim 11, wherein the shearing element does not include a traditional division of amplitude or division of wavefront self-referencing interference.

17. A shearography method comprising:
illuminating a surface with electromagnetic radiation;
receiving returned electromagnetic radiation from the surface;
transmitting the returned electromagnetic radiation through a first optical element formed from a geometric phase material;
outputting the returned electromagnetic radiation from the first optical element at a first circular polarization;
transmitting the returned electromagnetic radiation at the first circular polarization through an opposite second optical element formed from a geometric phase material that is oriented from 0° to 180° relative to the first optical element; and
linearly polarizing the transmitted electromagnetic radiation.

18. The shearography method of claim 17, wherein the second optical element formed from a geometric phase material that is oriented 180° relative to the first optical element.

19. The shearography method of claim 17, further comprising:
outputting electromagnetic radiation from the second optical in parallel beams towards a linear polarizer; and
polarizing, via the linear polarizer, the parallel beams of electromagnetic radiation output from the second optical element.

20. The shearography method of claim 17, further comprising:
outputting electromagnetic radiation from the second optical in parallel beams towards a focal plane array with micropatterned linear polarizers of multiple orientations;
polarizing, via the linear polarizer, the parallel beams of electromagnetic radiation output from the second optical element; and
recording an instantaneous plurality of phase-shifted specklegrams.
